(19) United States
(12) Patent Application Publication
(10) Pub. No.: US 2017/0126352 A1
(43) Pub. Date: May 4, 2017

(54) OPTICAL MODEM

(71) Applicant: ALCATEL-LUCENT USA, INC., Murray Hill, NJ (US)

(72) Inventors: Young-Kai CHEN, Berkeley Heights, NJ (US); Noriaki KANEDA, Westfield, NJ (US); Sian Chong J. LEE, Summit, NJ (US); Martin ZIRNGIBL, Middletown, NJ (US)

(73) Assignee: ALCATEL-LUCENT USA, INC.

(21) Appl. No.: 14/929,870

(22) Filed: Nov. 2, 2015

(51) Int. Cl. H04J 14/02; H04B 10/54; H04B 10/079; H04B 10/40

(52) U.S. Cl. CPC H04J 14/0257; H04B 10/40; H04B 10/541; H04B 10/07953

(57) ABSTRACT

Various embodiments relate to a method, device, and machine-readable storage medium including: an optical modem, the optical modem being configured to negotiate a format of an optical communication session with a remote optical transceiver via an optical fiber link; and wherein the optical modem is configured to select a transmission optical wavelength channel for transmitting data of the optical communication session in response to sensing the optical fiber link for light emission and determining that the transmission optical wavelength channel is unused based on the sensing.

### TECHNICAL FIELD

Various embodiments disclosed herein relate generally to optical communications.

### BACKGROUND

Optical communication is one of the primary means for communication on backhaul and backbone telecommunications networks. As the medium evolves, more sophisticated techniques are being employed to improve the bandwidth and reliability of fiber optic links. For example, wavelength-division multiplexing (WDM) is used to place multiple independent data streams on a single link, occupying adjacent wavelength channels within the fiber. Currently, dense WDM approaches can implement eighty or more different wavelength channels on a single optical fiber.

Another technique that has gained popularity is known as “coherent optical communication.” Prior to this technique, data was communicated according to a scheme whereby the intensity of the light corresponding to the wavelength channel was modulated to communicate digital data, e.g., in an On/OFF manner. According to coherent optical communication, data is placed on a wavelength channel by modulating a phase and amplitude of a carrier wave. Using this approach, different modulation schemes such as phase-shift keying (PSK) and quadrature amplitude modulation (QAM) may be used to transmit multi-bit symbols, thereby increasing bandwidth on a wavelength channel over simple ON/OFF keying.

### SUMMARY OF SOME EXEMPLARY EMBODIMENTS

A brief summary of various embodiments is presented below. Some simplifications and omissions may be made in the following summary, which is intended to highlight and introduce some aspects of the various exemplary embodiments, but not to limit the scope of the invention. Detailed descriptions of at least one embodiment adequate to allow those of ordinary skill in the art to make and use the inventive concepts will follow in later sections.

Various embodiments described herein relate to an apparatus including: an optical modem, the optical modem being configured to negotiate a format of an optical communication session with a remote optical transceiver via an optical fiber link; and wherein the optical modem is configured to select a transmission optical wavelength channel for transmitting data of the optical communication session in response to sensing the optical fiber link for light emission and determining that the transmission optical wavelength channel is unused based on the sensing.

Various embodiments are described wherein the optical modem is configured to reserve a reception optical wavelength channel for receiving communications of the optical communication session in response to detecting a session initiation signal on the reception optical wavelength channel from the optical fiber link.

Various embodiments are described wherein the optical modem includes a coherent optical receiver and is configured to sweep a wavelength of a local optical oscillator of the coherent optical receiver to determine whether an optical wavelength channel is unused.

Various embodiments are described wherein the optical modem is configured to sweep a wavelength of a local optical oscillator to detect a session initiation signal on an optical wavelength channel.

Various embodiments are described wherein the negotiation of the format includes selecting a signaling constellation from a set of constellations having different numbers of signal points, the set of signaling constellations including constellations with different numbers of signal points for coherent optical communication.

Various embodiments described herein relate to a method performed by an optical modem for establishing communication with a remote device, the method including: receiving a wavelength division multiplexed (WDM) optical signal at a receiver port of the optical modem, wherein the WDM optical signal is divided into a plurality of wavelength channels for carrying individual optical signals; analyzing at least one of the plurality of wavelength channels to select an unused wavelength channel that is currently not being used by any device for transmission of data; and using the selected wavelength channel to transmit communications to the remote device via the WDM optical signal.

Various embodiments described herein relate to a non-transitory machine-readable storage medium encoded with instructions for execution by a controller of an optical modem for establishing communication with a remote device, the non-transitory machine-readable storage medium including: instructions for receiving a wavelength division multiplexed (WDM) optical signal at a receiver port of the optical modem, wherein the WDM optical signal is divided into a plurality of wavelength channels for carrying individual optical signals; instructions for analyzing at least one of the plurality of wavelength channels to select an unused wavelength channel that is currently not being used by any device for transmission of data; and instructions for using the selected wavelength channel to transmit communications to the remote device via the WDM optical signal.

Various embodiments described herein relate to an optical modem for establishing communication with a remote device, the optical modem including: an optical receiver port; a optical demodulator including a tunable local oscillator configurable to isolate a wavelength channel from a plurality of wavelength channels carried by a wavelength division multiplexed (WDM) optical signal received via the optical receiver port; and an adaptive controller configured to: analyze at least one of the plurality of wavelength channels to identify an unused wavelength channel that is currently not being used by any device other than the optical modem and the remote device with which the optical modem is establishing communication, and configure the optical demodulator to use the identified unused wavelength channel to receive communications from the remote device via the WDM optical signal.

Various embodiments are described wherein analyzing at least one of the plurality of wavelength channels to identify an unused wavelength channel comprises: evaluating the plurality of wavelength channels to identify a plurality of unused wavelength channels; and selecting a wavelength channel from a preloaded table of wavelength channels, wherein the selected wavelength channel is known to be unused based on the evaluating step.

Various embodiments additionally include prior to selecting the unused wavelength channel: searching the plurality of wavelength channels for a session initiation transmitted by the remote device to the optical modem; and determining that the plurality of wavelength channels do not carry a session initiation transmitted by the remote device to the optical modem.

Various embodiments are described wherein the step of using the selected wavelength channel to transmit communications to the remote device via the WDM optical signal comprises transmitting a session initiation signal to the remote device via the selected wavelength channel.

Various embodiments are described wherein analyzing at least one of the plurality of wavelength channels comprises sweeping a wavelength of a local oscillator through multiple wavelength channels to locate an unused wavelength channel.

Various embodiments additionally include demodulating a first received signal on the selected wavelength channel according to a first set of demodulation characteristics; determining a signal quality of the first signal; selecting a second set of demodulation characteristics based on the signal quality; transmitting an identification of the second set of demodulation characteristics to the remote device; and demodulating a second received signal on the selected wavelength channel according to the second set of demodulation characteristics.

Various embodiments additionally include modulating a first transmitted signal according to a first set of modulation characteristics to transmit first data to the remote device on the selected wavelength channel; receiving an identification of a second set of modulation characteristics from the remote device; and modulating a second transmitted signal according to the second set of modulation characteristics to transmit second data to the remote device on the selected wavelength channel.

Various embodiments described herein relate to a method performed by an optical modem for establishing communication with a remote device, the method comprising: receiving a wavelength division multiplexed (WDM) optical signal at a receiver port of the optical modem, wherein the WDM optical signal is divided into a plurality of wavelength channels for carrying individual optical signals; locating, within the plurality of wavelength channels, a wavelength channel carrying a session initiation signal sent by the remote device for the optical modem; using the located wavelength channel to receive communications from the remote device via the WDM optical signal.

Various embodiments are described wherein locating the wavelength channel comprises: sweeping a wavelength of a local oscillator through multiple wavelength channels to locate the wavelength channel.

Various embodiments are described wherein locating the wavelength channel comprises: extracting a channel identifier from data received via a current wavelength channel carrying a session initiation signal; determining that the extracted channel identifier matches an expected channel identifier; and using the current wavelength channel as the located wavelength channel based on the outcome of the determining step.

Various embodiments additionally include using the located wavelength channel to transmit communications to the remote device via the WDM optical signal.

Various embodiments additionally include demodulating a first received signal on the located wavelength channel according to a first set of demodulation characteristics; determining a signal quality of the first signal; selecting a second set of demodulation characteristics based on the signal quality; transmitting an identification of the second set of demodulation characteristics to the remote device; and demodulating a second received signal on the located wavelength channel according to the second set of demodulation characteristics.

### BRIEF DESCRIPTION OF THE DRAWINGS

In order to better understand various example embodiments, reference is made to the accompanying drawings, wherein:

FIG. 1A is a block diagram illustrating an example of a pair of devices for communicating via an optical fiber link;

FIG. 1B is a block diagram illustrating an example of a pair of WDM devices for communicating via an optical fiber link

FIG. 2 is a flow chart illustrating an example of a method for negotiating a wavelength channel to be used between two communicating devices, e.g., the devices of FIG. 1;

FIG. 3 is a block diagram illustrating an example of a portion of an optical network;

FIG. 4 is a block diagram illustrating an example of an optical modem that performs coherent optical communications, e.g., in the portion of the optical network shown in FIG. 3;

FIG. 5 is a flow chart illustrating an example of a method for receiving data, in an optical modem, e.g., the optical modems of FIGS. 1-4;

FIG. 6 is a flow chart illustrating an example of a method for adapting modulation characteristics for data reception, e.g., in the optical modems of FIGS. 1-4;

FIG. 7 illustrates an example of a table for selection of modulation characteristics, e.g., according to the methods of FIGS. 6-7; and

FIG. 8 is a flow chart illustrating an example of a method for negotiating a wavelength channel for data reception, e.g., according to the methods of FIG. 2

### DETAILED DESCRIPTION

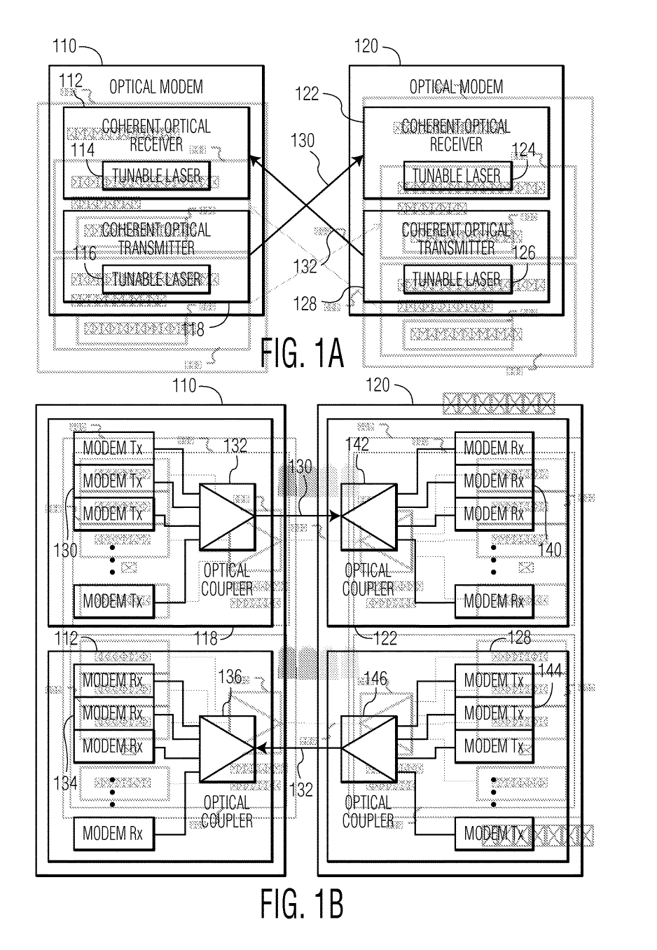

FIG. 1A is a block diagram illustrating an example of a pair of optical modes 110, 120 for communicating via an optical fiber links 130, 132. As shown, the optical modem 110 may include a coherent optical receiver 112 with a tunable laser 114 and a coherent optical transmitter 118 with a tunable laser 116. Likewise, the optical modem 120 may include a coherent optical receiver 122 with a tunable laser 124 and a coherent optical transmitter 126 with a tunable laser 128. The coherent optical receiver 114 may receive an optical signal from the coherent optical transmitter 126 via the optical fiber link 132. Also, the coherent optical receiver 124 may receive an optical signal from the coherent optical transmitter 116 via the optical fiber link 130. The optical modems 110, 112 may be configured to negotiate a format of an optical communication session including a transmission optical wavelength with one another via the optical fiber links 130, 132. The tunable lasers 114, 116, 124, 126 may be tuned to the desired optical wavelength in order to allow for optical communication between the optical modes 110, 120.

FIG. 1B is a block diagram illustrating an example of a pair of WDM optical modems 110, 120 for communicating via an optical fiber links 130, 132. FIG. 1B is similar to FIG. 1A, except that the optical modems in FIG. 1B support WDM operation. As shown, the optical modem 110 may include a coherent optical receiver 112 with a plurality of modem receivers (Rx) 134 connected to an optical coupler 136. Each of the modem Rx 134 is tuned to a specific wavelength, and optical signals with different wavelengths are combined by the optical coupler 136. The optical modem 110 may also include coherent optical transmitter 118 with a plurality of modem transmitters (Tx) 130 connected to an optical coupler 134. Likewise, the optical modem 120 may include a coherent optical receiver 122 with a plurality of modem Rx 140 connected to an optical coupler 142. Each of the modem Rx 140 is tuned to a specific wavelength, and optical signals with different wavelengths are combined by the optical coupler 136. The optical modem 120 may also include coherent optical transmitter 128 with a plurality of modem transmitters (Tx) 144 connected to an optical coupler 146.

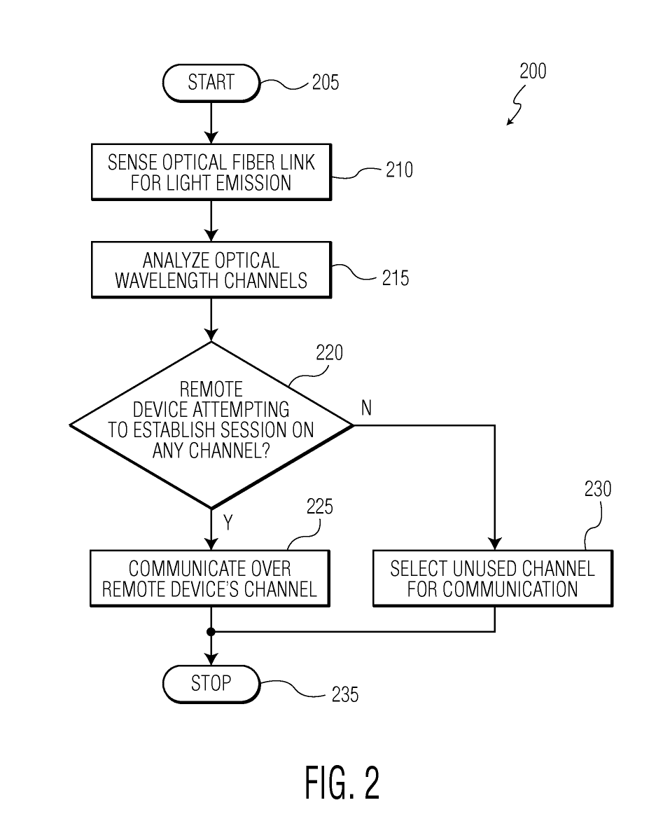

FIG. 2 is a flow chart illustrating an example of a method 200 for negotiating a wavelength channel to be used between two communicating devices, e.g., the devices of FIG. 1. The example method 200 begins in step 205 and proceeds to step 210 where the optical modem may sense an optical fiber link for light emission. After receiving light via the optical fiber link the optical modem, in step 215, analyzes the optical wavelength channels of the received light. For example, the optical modem may search the wavelength channels for session initiation signals and/or unused signals. In step 220, the optical modem determines whether, based on the analysis, the remote device, such as the remote optical transceiver 120 of FIG. 1, is attempting to establish a communications session over any received wavelength channel. For example, the optical modem may attempt to locate a session initiation signal. If so, the optical modem commences communication over the wavelength channel which carried the remote device's attempt to establish as session. The method 200 then ends in step 235

If, on the other hand, the optical modem does not locate any attempt by a remote device to establish a session on any channel, the method 200 proceeds to step 230. In step 230, the optical modem selects an unused wavelength channel (known to be unused based on the analysis step 215) and begins transmitting information on the selected channel. For example, the optical modem may begin transmitting a session initiation signal to the remote device via the selected wavelength channel. The method 200 then proceeds to end in step 235.

An optical communication system may utilize a series of fiber optic links between transponders that are connected symmetrically. In other words, there may be no clear distinction between two connected transponders such that the transponders may be distinguished as master/slave or uplink/downlink pairs. This is not an issue as of today as the, transmission characteristics such as modulation schemes, symbol rates, and wavelength carefully designed and planned prior to the network installation, and controlled by software running in the control system with local area network (LAN) connectivity. As such, the task of physical layer configuration is left to the control software and network operator and advanced features such as automatic reconfigurations based on changing network environments or selection of an available wavelength channel on a multiplexed link are not readily available.

To reduce the great effort of such a network operator task, it may be desirable to provide an optical modem that can negotiate link characteristics with other similar modems. Accordingly, some of the embodiments described herein provide an optical modem that monitors signal quality and, based on the signal strength, chooses an appropriate set of characteristics (e.g., modulation and symbol rate) to increase link utilization. Some embodiments also provide a method for one optical modem or a par of optical modems to select a wavelength channel that will be used for communications.

The description and drawings presented herein illustrate various principles. It will be appreciated that those skilled in the art will be able to devise various arrangements that, although not explicitly described or shown herein, embody these principles and are included within the scope of this disclosure. As used herein, the term, “or,” as used herein, refers to a non-exclusive or (i.e., or), unless otherwise indicated (e.g., “or else” or “or in the alternative”). Additionally, the various embodiments described herein are not necessarily mutually exclusive and may be combined to produce additional embodiments that incorporate the principles described herein.

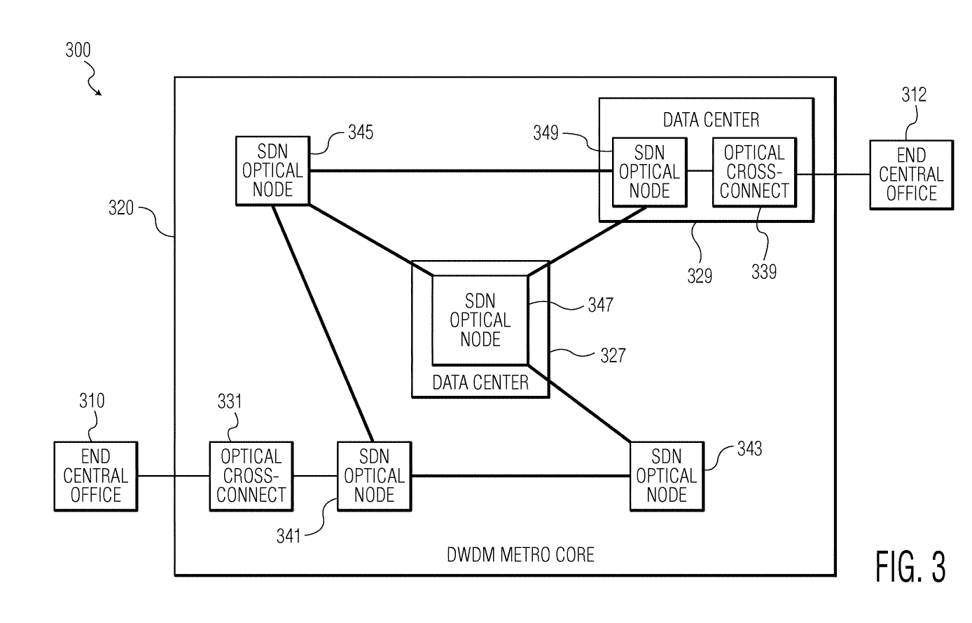

FIG. 3 illustrates an example of an optical network 300. Specifically, the network 300 may constitute part of a backbone network for connecting two or more geographically distributed network segments. For example, as shown, two end central offices 310, 312 are connected via a dense WDM (DWDM) metro core 320. The end central offices 310, 312 may both connect to one or more additional network devices (not shown) including, eventually, user devices (not shown). As such, a user device (user) attached to end central office 310 may transmit data toward the end central office 310 which, in turn, may transmit the data over the DWDM metro core 320 to the other end central office 312. The end central office 312 may then transmit the data toward its eventual destination such as a server or additional user device (not shown). Various additional uses for the network 300 will be apparent. It will also be apparent that numerous additional end central offices (not shown) may also connect to the DWDM metro core 320.

The DWDM metro core 320 includes multiple optical devices 331-349 that may serve to provide connectivity between the end central offices 310, 312. As shown, one or more of these devices may be situated among multiple, potentially geographically-distributed data centers 327, 329. For example, one of data centers 329 that is closest to one of the end central offices 312, may include an optical cross-connect device 339 for enabling communication into and out of the core 320. Similarly, an optical cross connect 331 that is not situated in a data center may communicate with the other end central office 310. As such, the end central offices 310, 312 and optical cross-connect devices 331, 339 may each include at least one optical modem to support such communication. It will be apparent that additional cross connects (not shown) may be provided throughout the core such as, for example, at data center 327. The optical cross-connect devices 331, 339 may perform switching of optical signals between their respective end central offices 310, 312 and other optical nodes 341, 349 within the core.

The core 320 also includes optical nodes 341-349 for implementing communications links therebetween. As such, some of the optical nodes 341-349 may include one or more hardware modems to enable such communication. The various links established among the optical nodes 341-349 may provide one or more routes for data to follow in traversing the DWDM metro core 320. For example, data traveling from one end central office 310 to another central office 312 may travel through optical nodes 341, 345, 349 or optical nodes 341, 343, 347, 349 to eventually reach the destination side of the core 320. The optical nodes 341-349 and links therebetween may be established according to virtually any network topology such as, for example, a mesh or ring topology.

In various embodiments, one or more of the data centers 327, 329 may include additional equipment such as, for example, servers, databases, routers, etc. In some such embodiments, the data center may support cloud-based services. For example, servers within data center 327 may support multiple virtual machines (VMs) for performing various functions. For example, virtual machines may be deployed within one or more of the data centers 327, 329 to function as customer premise equipment (CPEs), provider edge nodes (PEs), radio access networks (RANs), border network gateways (BNGs), or serving gateways (SGWs). Various other applications will be apparent. As such, in some embodiments, the data center optical components 339, 347, 349 may also be flexibly provisioned in accordance with cloud computing principles. For example, when an application is deployed to include communication between machines 327, 329, an SDN controller (not shown) or other controllers within the data centers or elsewhere may configure previously unallocated optical modems within the data centers 327, 339 to establish a new link therebetween, and then further configure the other application components to utilize the newly-established link.

Given varying distances between data centers, fiber quality, and other considerations, different links may operate according to different modulation schemes (e.g., modulation schemes associated with constellations having different numbers of constellation points) and symbol rates. For example, different links may support different maximum transfer rates (e.g., as provided by different modulation schemes) with acceptable signal quality (e.g., as determined by a measured signal-to-noise ratio) For example, the link between nodes 341, 345 may operate according to polarization-division-multiplexed (PM) 64 quadrature amplitude modulation (64QAM) for a bit rate of 480 Gb/s when the optical signal-to-noise ratio (OSNR) is sufficiently high at optical transponders. But, the link between nodes 341 and 343 might not support such modulation protocol due to low OSNR value(s). Then, the link between nodes 341 and 343 may only support PM quadrature phase shift keying (PM-QPSK) for 112 Gb/s. Further, the potential for change to the topology of the network 320 may introduce the need to change the characteristics of operational links. For example, if the optical node 343 is moved to a closer data center either through physical movement or reprovisioning of the node, the link may then support the 400 Gb/s alternative. It may be undesirable to provide different modem equipment for each potential link and further may be undesirable for the modem equipment to be changed in response to evolving topologies or demands. Accordingly, the following examples provide embodiments of a modem that may intelligently adapt link rates as useful.

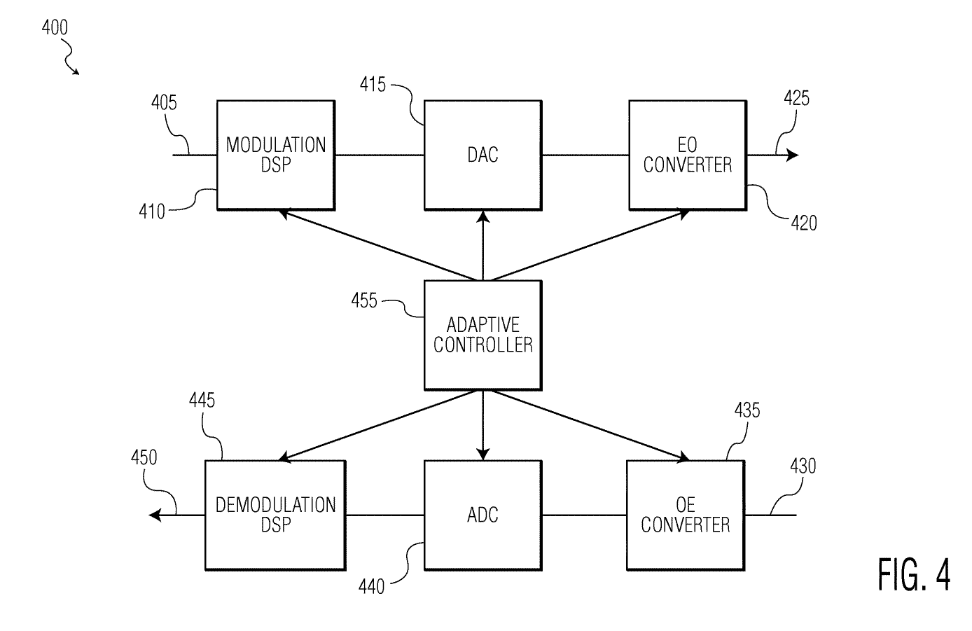

FIG. 4 illustrates an example of an optical modem 400. The optical modem 400 may be incorporated into any device that communicates on an optical network such as, for example, the end central offices 310, 312, optical cross-connects 331, 339, or optical nodes 341-349 of the example network 300. It will be understood that the network 300 is only one example of an optical network and that the optical modem 400 may be incorporated into devices in other networks.

The example modem 400 includes two data paths: a reception path and a transmission path. The transmission path begins at data input port 405 connected to the host system in which the optical modem is installed. The data input port 405 may be virtually any appropriate data connection such as an Ethernet port, a serial data port, or USB port. In other embodiments, the optical modem 400 may be integrated with other devices. For example, an optical modem and Ethernet interface may be implemented on a single card. In such embodiments, the data I/O port may simply be a data connection to the other integrated device. Various alternative types of I/O ports 405 will be apparent.

Data received via the data input 405 from the host device for transmission is modulated by a modulation digital signal processor (DSP) 410. A digital to analog converter (DAC) 415 receives and converts the digital modulated input data into an analog signal. The electro-optical (EO) converter 420 receives and converts the modulated analog signal to an optical signal which is output to the optical output 425.

The reception path begins at an optical signal input 430. The optical-electro (OE) converter 435 receives and converts the optical signal from the optical signal input 430 into an electrical signal. An analog to digital converter (ADC) 440 converts the electrical signal from an analog signal into a digital signal. The demodulation DSP 445 demodulates the digital electrical signal to produce an output data signal which is output to the data output 450.

The data may be transmitted and received in a frame that includes thousands or more bits. Each frame has a header to indicate what modulation format and other information being used. The EO converter 420 may include optical dual polarization IQ modulator, and the OE converter 435 may include an optical hybrid for polarization and phase diversity receiver.

In various embodiments, the adaptive controller 455 may be configurable to operate according to different modulation schemes; for example, the modulation DSP 410 may perform constellation mapping and pulse shaping for different modulation formats such as polarization multiplexed binary phase shift keying (PM-BPSK), polarization multiplexed quadrature phase shift keying (PM-QPSK), PM-16QAM and etc.

Further the adaptive controller 455 may control the modulation DSP 410 and the demodulation DSP 445. The modulation DSP 410 and demodulation DSP 445, e.g., an ASIC or FPGA, may compensate for chromatic dispersion, perform channel equalization and/or carrier recovery. The adaptive controller 455 may include hardware for controlling the modem 400 to implement a given demodulation scheme at a given baud rate. For example, the adaptive controller 455 may include a register or other device for storing an indication of the currently configured modulation scheme for the reception path and hardware for delivering control signals to the various elements of the modem 400 to enable the appropriate algorithms for demodulating the signal according to the scheme identified in the register.

The demodulation DSP 410 also may include a symbol rate checker or clock recovery for determining the currently configured symbol rate. On each pulse of the clock, the demodulation DSP 410 may receive a plurality of bits from the ADC 440 and OE converter 435 from the received symbol, and store the bits into a data buffer. The buffered data may then be read out to the host device via the data output 450.

The adaptive controller 455 may be a microprocessor, FPGA, ASIC, or other hardware suitable for performing the functions described herein. As will be described in greater detail with respect to FIGS. 3-8, the modem 400 may monitor the signal quality of the received signal according to one or more metrics (e.g., a signal-to-noise ratio or bit-error rate) and, based on the signal quality, determine whether a change to the modulation characteristics would be appropriate. For example, if the SNR is measured to be very high, the adaptive controller 455 may change the modulation scheme or symbol rate to provide a higher bit rate. Conversely, if the SNR is measured to be unsatisfactorily low, the adaptive controller 455 may change the modulation scheme or symbol rate to provide a lower bit rate and better signal quality. Additionally, where a wave division multiplexed signal is received at the optical signal port 430, the adaptive controller 455 may operate to negotiate and isolate a wavelength channel.

In some embodiments, the adaptive controller 455 may also interface with an SDN controller, which may be a remote device. In such embodiments, the SDN controller may transmit an instruction to the adaptive controller 455 to establish a communication link with an identified remote modem. Upon receiving such an instruction, the adaptive controller 455 may begin the channel selection and rate adaptation processes described herein to effect establishment of the new link.

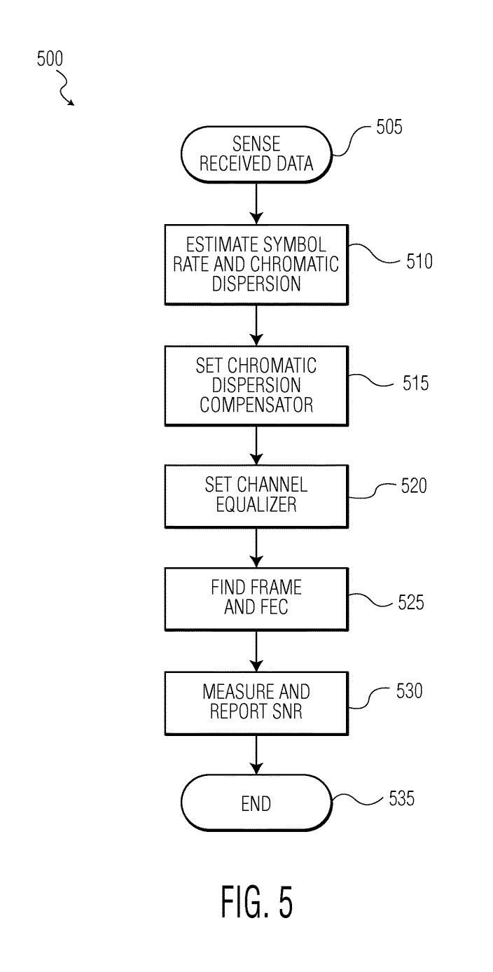

FIG. 5 illustrates an example of a method 500 for receiving data. The method 500 may be performed by the demodulation DSP 440, OE converter 435, adaptive controller 455, or any combination thereof of the example optical modem 400. It will be apparent that various steps described with respect to the method 500 (as well as the other methods described herein) may be implemented in hardware. For example, some steps may describe functions performed by an ASIC such as a digital signal processor.

The method 500 begins in step 505 in response to the modem sensing that data has been received. The modem then estimates the symbol rate and chromatic dispersion in step 510 that the signal has experienced in transit and then sets a chromatic dispersion compensator in step 515 to account for this signal distortion. In step 520, the modem sets the channel equalizer to ensure that the power level of the received signal is appropriate for the demodulation hardware. In step 525, the modem demodulates the data, locates a frame, and applies forward error correction.

In step 530, the modem may measure the signal quality by, for example, calculating a measure of the SNR thereat. Where a component such as the demodulation DSP 445 of the example optical modem 400 measures the SNR, the demodulation DSP 445 then reports the SNR to the adaptive controller 455. Where the controller itself measures the signal quality by, for example, determining the bit error rate (BER), the controller may proceed to perform adaptation (e.g., according to method 600, described below) without reporting to another device. In step 535, the method 500 ends.

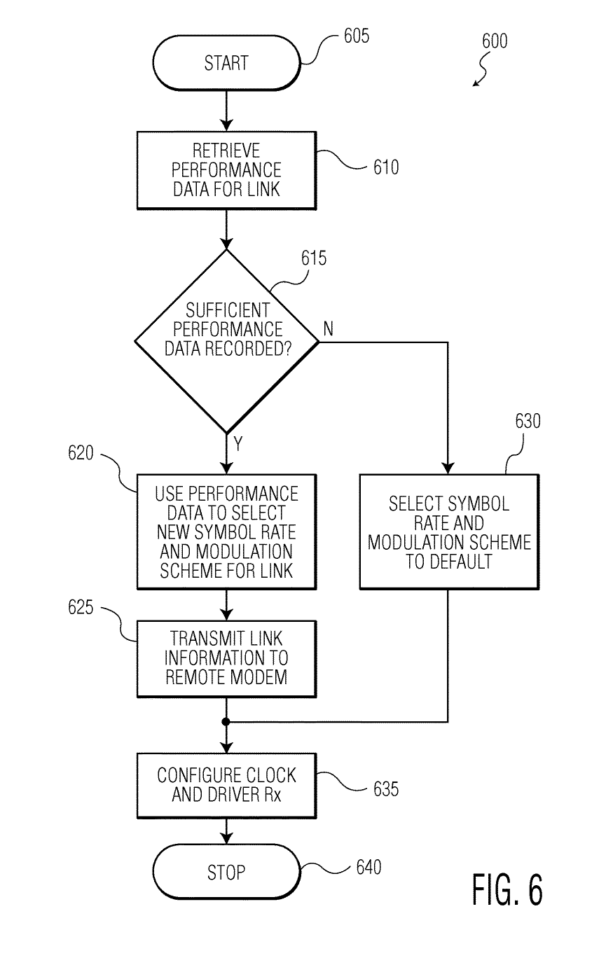

FIG. 6 illustrates an example of a method 600 for adapting modulation characteristics for data reception. The method 600 may be performed by the adaptive controller 455 of the example optical modem 400. The method 600 may be performed periodically, in response to the beginning of a new incoming optical signal or session, in response to the calculation of a signal quality metric, or in response to a signal quality metric falling below or rising above a threshold.

The method begins in step 605 and proceeds to step 610 where the modem retrieves performance data, such as SNR or BER values, for the link. In step 615, the modem determines whether sufficient performance data has been reported or otherwise retrieved for the purpose of adjusting the link. For example, in some embodiments, a predefined number of performance data samples may be obtained prior to performing rate adjustment. Alternatively, more sophisticated analysis may be performed to determine whether sufficient data is available. For example, the modem may wait until receiving a number of samples having a deviation less than a given threshold before attempting rate adaptation. In other embodiments, a single sample may be sufficient to initiate rate adaptation.

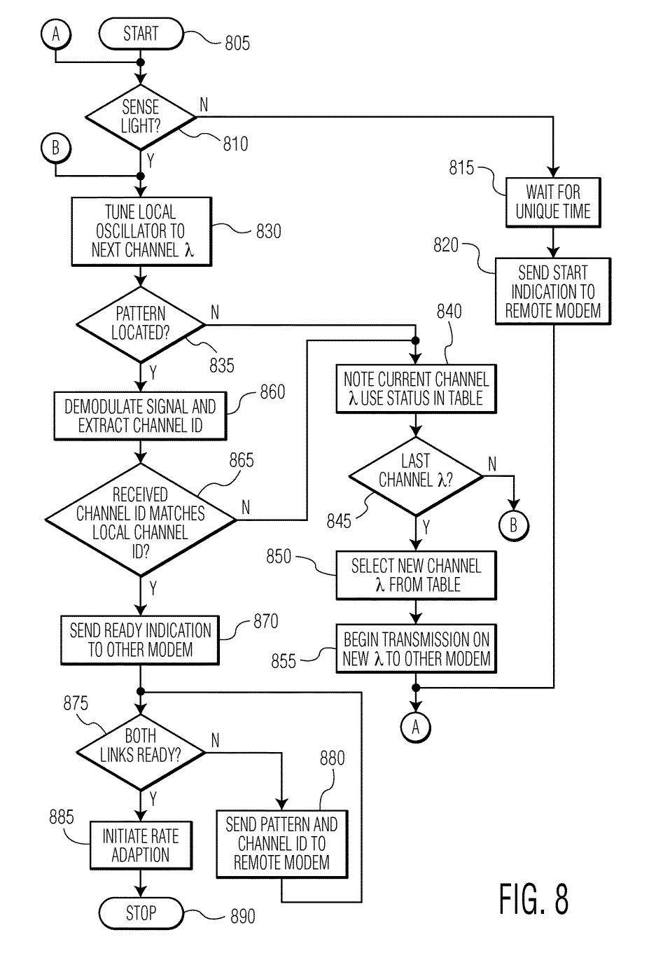

If sufficient performance data is available, the method 600 proceeds to step 620 where the modem determines, based on the performance data, a new symbol rate and/or a new modulation scheme to be used by the remote modem to modulate data onto the optical carrier for transmission over the fiber link (and by the local hardware to subsequently demodulate the received signal). Various methods may be used to determine new modulation characteristics for the link. For example, according to various embodiments, the optical modem may refer to a table that correlates various SNR values or other metrics to modulation characteristics, an example of which will be described in greater detail below with respect to FIG. 8. Alternatively, the modem may utilize a mathematical model to determine how to adjust the symbol rate or modulation scheme to achieve a desired SNR or other metric.

Next, in step 625, the modem transmits this new link information to the remote modem to indicate that the remote modem should begin transmitting data on the channel according to the new modulation characteristics. In some embodiments, the modem transmits the information over another optical link back to the remote modem which may be operating according to a different set of modulation characteristics which may not be fully configured. For example, at the same time that the local modem executes the method 600 to determine modulation characteristics for its incoming signal, the remote modem may simultaneously execute a similar method to determine other modulation characteristics to be used for its own incoming signal. As such, from the point of view of the local modem, step 625 may include transmitting link information over an outgoing link according to default modulation characteristics or according to modulation characteristics chosen by the remote modem.

If, on the other hand, sufficient performance data is not yet available, the method proceeds to step 630 where the modem selects the system default modulation characteristics. For example, the local modem and the remote modem may be configured to utilize a default of 10 Gbaud PM-QPSK prior to rate adaptation. As such, communication is enabled prior to selection of modulation characteristics in step 620.

In step 635, the device configures the demodulation DSP 445 (including the clock) according to the characteristics selected in step 620 or 630. As such, future signals received from the remote modem will be demodulated according to such modulation characteristics (which, in the case of demodulation, may also be referred to as “demodulation characteristics”). The method 600 then proceeds to end in step 640.

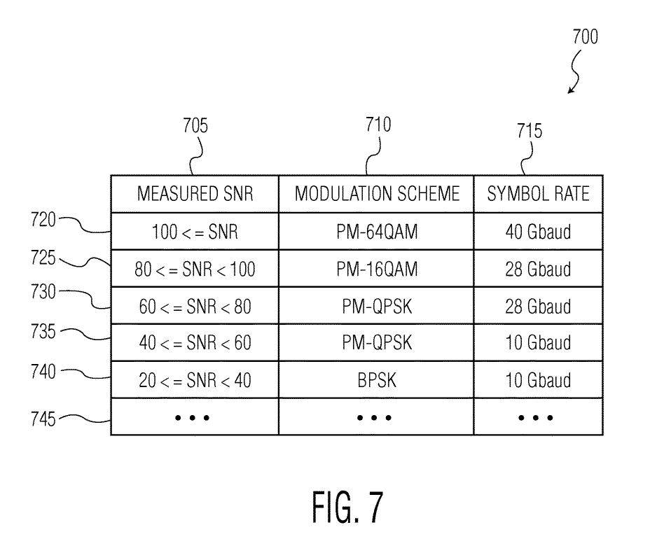

FIG. 7 illustrates an example of a table 700 for selection of modulation characteristics. The table 700 may be used, for example, in step 620 of method 600 to determine the modulation characteristics to be used based on measured signal quality. It will be apparent that various alternative data structures may be used such as, for example, a hash table.

As shown, the table 700 may include a measured SNR field 705, a modulation scheme field 710, and a symbol rate field 715. The measured SNR field 705 may store one or more thresholds for determining whether an entry is applicable to the link while the modulation scheme field 710 and the symbol rate field 715 indicate the modulation characteristics to be used when an entry is applicable.

As an example, as first entry indicates that when the measured SNR is greater than or equal to 100 (indicating a very strong signal), the remote modem should begin transmitting the signal as a 40 Gbaud PM-64QAM signal (i.e., a 480 Gb/s signal). As another example, entry 725 indicates that when the SNR is between 80 and 100, the remote modem should begin transmitting the signal as a 28 Gbaud PM-16QAM signal (i.e., a 224 Gb/s signal). The meanings of the remaining entries 730, 735, 740 will be apparent. The table 700 may include numerous additional entries 745.

In various environments, the signal received by a modem may be a wave-division multiplexed signal including a single channel that the modem is to extract and demodulate. For example, the modem may be deployed to perform optical add/drop functionality or may be part of a point-to-point connection over WDM. As with selecting modulation characteristics, the two modems according to various embodiments described herein are able to negotiate a set of wavelength channels to use for communication over such a multiplexed signal.

FIG. 8 illustrates an example of a method 800 for negotiating a wavelength channel for data reception. In various embodiments, such as the embodiment described in connection with method 800, the modem may use the same wavelength channel for both data reception and transmission with a remote device. Various modifications to provide independent negotiation of the reception and transmission wavelength channels will be apparent. The method 800 begins in step 805 and proceeds to step 810 where the modem determines whether the reception port is receiving any light. If not, the method 800 proceeds to step 815 where the modem waits for a time. In various embodiments, the time is determined to be unique to the modem executing the method 800. For example, a unique identifier for the modem may be used to generate an upcoming time for which the modem will wait in step 815. After the time has been reached, the method 800 proceeds to step 820 where the modem lowers the attenuation of the local variable optical attenuator (VOA) and sends a start indication to the remote modem over a selected wavelength channel, thereby indicating that the remote modem should begin transmitting at least a session initiation pattern (such as the AIS) and client data if available. The selected wavelength channel for transmission may be a default wavelength channel, a wavelength channel chosen through independent operation of a method similar to method 800 by the remote modem, or any other wavelength channel that has been chosen for use on the transmission link. This initial reception channel may be a default wavelength channel, may be chosen arbitrarily from a table of possible wavelength channels, or selected in some other manner.

In step 830, the modem tunes its local reception oscillator to locate a wavelength channel that carries a signal. For example, the modem may sweep the local reception oscillator through each wavelength associated with a wavelength channel until a signal carrying the start pattern is found or until all used wavelength channels have been tested. In step 835, the modem determines whether the signal on the isolated wavelength channel carries the session initiation pattern. If not, the modem may proceed to step 940 where the modem notes in a local table the observed use status of the current isolated channel. For example, if active communications were sensed on the current wavelength channel, the modem notes in a table entry associated with the current channel that the channel is in use. If, on the other hand, no signal was detected on the current wavelength channel, the modem notes in the table entry for the current wavelength channel that the channel is unused.

Next, in step 945, the modem determines whether the current channel is the last channel to be analyzed. In other words, the modem determines whether the local oscillator has completed a full sweep of all of the possible wavelength channels. If not, and additional wavelength channels remain for consideration, the method 800 loops back to step 830. Otherwise, the method 800 proceeds to step 850 where the modem selects a new channel wavelength from the preloaded table. The modem then begins transmitting a session initiation signal to the remote modem via the new wavelength channel in step 855 which, if the remote modem is using a similar method to negotiate a channel, will be expected to also begin transmission on the selected wavelength channel. The method 800 then loops back to step 810 to continue waiting for the expected signal

If, on the other hand, the modem determines that the isolated signal does include the pattern in step 835, the method 800 proceeds to step 860 where the modem demodulates the signal and extracts a channel ID from the payload of the frame. This received channel ID is then compared to the local channel ID to determine whether the signal is intended for the local modem by the remote modem. If the channel IDs do not match, the method 800 proceeds to step 840.

After receiving a start indication including a matching channel ID, the method proceeds from step 865 to step 870 where the modem transmits an indication that the reception link is ready for the next step to the remote modem. At this point, it is possible that the local modem may have already received a similar ready indication from the remote modem with respect to the transmission link. In step 875, the modem determines whether this is the case and that both links are therefore ready. If both links are not ready, the modem may continue transmitting the start pattern and channel ID to the remote modem (e.g., over wavelength channels selected by the remote modem in a manner similar to that described above with respect to the local modem) until such a ready indication is received. Once both links are ready, the modem will initiate rate adaptation (e.g., the example rate adaptation methods 600) in step 885 and the method 800 proceeds to end in step 890.

Having described the methods employed by various embodiments described herein, an example of the operation of a modem according to these embodiments will now be explained in the context of two example modems 400, operating according to the methods 500, 400, 600, 800 in conjunction with the table 700. For the purposes of this example, the modems communicate via a WDM link.

Initially, the local modem 400 senses light at its optical port 430 but, after sweeping the local oscillator through the possible wavelength channels, is unable to find any signal bearing the AIS (which, in this example, is adopted as the predetermined pattern indicating a transmission initiation). As such, the local modem 400 selects the first wavelength channel λ1 from its preloaded table and transmits this selection to the remote modem in steps 850, 855 via the transmission port 425. It will be understood that a similar process for link establishment is being performed for the link attached to the transmission port by the remote modem.

The remote modem, upon receiving this identification of channel λ1, begins transmitting the AIS and channel ID over channel λ1. The local modem 400 tunes its local oscillator to isolate λ1 in step 830 but determines in step 835 that another signal lacking the AIS is present on the channel λ1 (thereby indicating that λ1 is already in use). Returning to steps 850, 855, the local modem transmits the next wavelength channel, λ2, to the remote modem, which then begins transmitting the AIS on λ2. The local modem 400 isolates λ2 in step 930, locates an AIS in step 935, but determines that the payload currently carries a different channel ID associated with two other devices. The local oscillator loops back to step 930 to ensure that λ2 is still isolated and, in step 935, determines that a signal lacking the AIS is now present on λ2 (suggesting that the two other devices successfully established a link on λ2 which is therefore now in use). The local modem selects a new wavelength channel λ3 in step 850 which the remote modem begins using for transmission of the AIS and channel ID.

The local modem then isolates λ3 in step 930, locates an AIS in step 935, and again finds that the channel ID carried by the signal is not a match for the locally-configured channel ID. The method 900 loops back to step 930 where the modem ensures that λ3 is isolated, again locates an AIS and, this time, finds that the signal carried the matching channel ID (suggesting that, this time, the other devices were unsuccessful in establishing a link on λ3, which is therefore likely available). The local modem then transmits a ready indication to the remote node in step 870 and determines that a similar indication has not been received in step 875. As such, the local modem continues to transmit the AIS and channel ID over its transmission port 425 via different wavelength channels at the instruction of the remote node, traversing wavelength channels λ1, λ2, λ3, λ4 and λ5 before receiving a ready indication.

The adaptive controller 455 of the local modem 400 configures the DSPs 410, 445 according to a default scheme of 10 Gbaud PM-QPSK and begins sending and receiving client data. After calculating an SNR of 310 for the received signal, the local adaptive controller 455 consults the table 800 in step 620 to determine that the modulation characteristics should be changed to 40 Gbaud PM-64QAM according to entry 820. The local modem 400 transmits an identification of these new characteristics to the remote modem in step 625 and then configured its own demodulation DSP 445 to begin demodulating the received signal according to 40 Gbaud PM-64QAM. The remote modem, upon receiving the link information transmitted by the local modem 400 in step 625, configures its own demodulation DSP 445 in step 720 to begin modulating outgoing data using 40 Gbaud PM-64QAM. During the same time, the remote modem 400 measures an SNR of 70 on the link in the other direction, selects modulation characteristics of 28 Gbaud PM-QPSK to be configured for the remote modem's 400 demodulation DSP 445 and the local modem's 400 modulation DSP 410. Thus, through operation of the various methods and devices described herein, a local modem and remote modem have established two data links therebetween over a WDM link: a 40 Gbaud PM-64QAM link on wavelength channel λ3 from the remote modem to the local modem and a 28 Gbaud PM-QPSK on wavelength channel λ5 in the reverse direction from the local modem to the remote modem.

According to the foregoing, various embodiments enable optical modems to intelligently adapt their transmission characteristics to suit their environment. For example, by monitoring received signal strength, a receiving modem can instruct a transmitting modem to use a more beneficial modulation scheme or symbol rate. By splitting responsibility for modulation characteristic and wavelength channel selection between the two reception paths, modulation characteristics can be established without relying on an arbitration of a master/slave relationship or the operation of a higher layer arrangement such as a LAN. Various additional benefits will be apparent in view of the foregoing.

It should be apparent from the foregoing description that various exemplary embodiments of the invention may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A non-transitory machine-readable storage medium may include any mechanism for storing information in a form readable by a machine, such as a personal or laptop computer, a server, or other computing device. Thus, a non-transitory machine-readable storage medium may include read-only memory (ROM), random-access memory (RAM), magnetic disk storage media, optical storage media, flash-memory devices, and similar storage media and excludes transitory signals.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

1. An apparatus comprising:
an optical modem, the optical modem being configured to negotiate a format of an optical communication session with a remote optical transceiver via an optical fiber link;
wherein the optical modem is configured to select a transmission optical wavelength channel for transmitting data of the optical communication session in response to sensing the optical fiber link for light emission and determining that the transmission optical wavelength channel is unused based on the sensing; and
wherein the optical modem includes a coherent optical receiver and is configured to sweep a wavelength of a local optical oscillator of the coherent optical receiver to determine whether an optical wavelength channel is unused.

2. The apparatus of claim 1, wherein the optical modem is configured to reserve a reception optical wavelength channel for receiving communications of the optical communication session in response to detecting a session initiation signal on the reception optical wavelength channel from the optical fiber link.

3. (canceled)

4. (canceled)

5. The apparatus of claim 2, wherein the optical modem is configured to sweep a wavelength of a local optical oscillator to detect a session initiation signal on an optical wavelength channel.

6. The apparatus of claim 1, wherein the optical modem includes a coherent optical receiver is configured to sweep a wavelength of a local optical oscillator of the coherent optical receiver to sense a session initiation signal on an optical wavelength channel.

7. The apparatus of claim 1, wherein the negotiation of the format includes selecting a signaling constellation from a set of constellations having different numbers of signal points, the set of signaling constellations including constellations with different numbers of signal points for coherent optical communication.

8. The apparatus of claim 1, wherein the negotiation of the format includes selecting a signaling constellation from a set of signaling constellations having different numbers of signal points, the set of signaling constellations including, at least, constellations with different numbers of signal points for pulse amplitude modulation.

9. The apparatus of claim 1, wherein the optical modem is configured to turn on light after unique time waiting (interval) time.

10. A method performed by an optical modem for establishing communication with a remote device, the method comprising:
receiving a wavelength division multiplexed (WDM) optical signal at a receiver port of the optical modem, wherein the WDM optical signal is divided into a plurality of wavelength channels for carrying individual optical signals;
analyzing at least one of the plurality of wavelength channels to select an unused wavelength channel that is currently not being used by any device for transmission of data; and
using the selected wavelength channel to transmit communications to the remote device via the WDM optical signal;
wherein the optical modem includes a coherent optical receiver; and
wherein analyzing at least one of the plurality of wavelength channels comprises sweeping a wavelength of a local oscillator of the coherent optical receiver through multiple wavelength channels to locate an unused wavelength channel.

11. The method of claim 10, wherein analyzing at least one of the plurality of wavelength channels to identify an unused wavelength channel comprises:
evaluating the plurality of wavelength channels to identify a plurality of unused wavelength channels; and
selecting a wavelength channel from a preloaded table of wavelength channels, wherein the selected wavelength channel is known to be unused based on the evaluating step.

12. The method of claim 11, further comprising, prior to selecting the unused wavelength channel:
searching the plurality of wavelength channels for a session initiation transmitted by the remote device to the optical modem; and
determining that the plurality of wavelength channels do not carry a session initiation transmitted by the remote device to the optical modem.

13. The method of claim 10, wherein the step of using the selected wavelength channel to transmit communications to the remote device via the WDM optical signal comprises transmitting a session initiation signal to the remote device via the selected wavelength channel.

14. (canceled)

15. The method of claim 10, further comprising:
demodulating a first received signal on the selected wavelength channel according to a first set of demodulation characteristics;
determining a signal quality of the first signal;
selecting a second set of demodulation characteristics based on the signal quality;
transmitting an identification of the second set of demodulation characteristics to the remote device; and
demodulating a second received signal on the selected wavelength channel according to the second set of demodulation characteristics.

16. The method of claim 15, further comprising:
modulating a first transmitted signal according to a first set of modulation characteristics to transmit first data to the remote device on the selected wavelength channel;
receiving an identification of a second set of modulation characteristics from the remote device; and
modulating a second transmitted signal according to the second set of modulation characteristics to transmit second data to the remote device on the selected wavelength channel.

17. A method performed by an optical modem for establishing communication with a remote device, the method comprising:
receiving a wavelength division multiplexed (WDM) optical signal at a receiver port of the optical modem, wherein the WDM optical signal is divided into a plurality of wavelength channels for carrying individual optical signals;
locating, within the plurality of wavelength channels, a wavelength channel carrying a session initiation signal sent by the remote device for the optical modem;
using the located wavelength channel to receive communications from the remote device via the WDM optical signal;
wherein the optical modem includes a coherent optical receiver; and
wherein locating the wavelength channel comprises sweeping a wavelength of a local oscillator of the coherent optical receiver through multiple wavelength channels to locate the wavelength channel.

18. (canceled)

19. The method of claim 17, wherein locating the wavelength channel comprises:
extracting a channel identifier from data received via a current wavelength channel carrying a session initiation signal;
determining that the extracted channel identifier matches an expected channel identifier; and
using the current wavelength channel as the located wavelength channel based on the outcome of the determining step.

20. The method of claim 17, further comprising:
using the located wavelength channel to transmit communications to the remote device via the WDM optical signal.

21. The method of claim 17, further comprising:
demodulating a first received signal on the located wavelength channel according to a first set of demodulation characteristics;
determining a signal quality of the first signal;
selecting a second set of demodulation characteristics based on the signal quality;
transmitting an identification of the second set of demodulation characteristics to the remote device; and
demodulating a second received signal on the located wavelength channel according to the second set of demodulation characteristics.
